(19) United States
(12) Patent Application Publication
(10) Pub. No.: US 2026/0179313 A1
(43) Pub. Date: Jun. 25, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Keisuke MORISAWA, Kanagawa (JP)

(21) Appl. No.: 19/417,455

(22) Filed: Dec. 12, 2025

(30) Foreign Application Priority Data
Dec. 25, 2024 (JP) 2024-229358

(51) Int. Cl. G06T 15/20; G06T 7/50; G06T 7/70

(52) U.S. Cl. CPC G06T 15/205; G06T 7/50; G06T 7/70; G06T 2207/30244

(57) ABSTRACT

An object is to provide a user with a virtual viewpoint image having higher added values in accordance with the number of figures contained in a captured image. An information processing apparatus according to the present disclosure analyzes a captured image obtained by performing image capturing of a three-dimensional shaped product of an object to obtain information on the three-dimensional shaped product. Then, the information processing apparatus determines and generates a content of a virtual viewpoint image based on the number of three-dimensional shaped products contained in the captured image.

### BACKGROUND

### Field of the Technology

The present disclosure relates to a technique of generating a virtual viewpoint image from a 3D figure.

### Description of the Related Art

There is a technique in which on an image obtained by performing image capturing of a 3D model figure (hereinafter, referred to as a “figure”) with a mobile terminal such as a smartphone or a tablet, a virtual viewpoint image of a scene relating to the figure is superimposed and displayed. This technique that is capable of displaying a person and the like who do not exist in the real world as if the person and the like exist in the real world is called AR (Augmented Reality), and has been widely used in the fields of entertainment, education, training, and the like. Japanese Patent Laid-Open No. 2022-131778 discloses a technique of extracting a two-dimensional marker from an image obtained by performing image capturing of a figure expressing a critical moment in sports, and generating a virtual viewpoint image in the case of viewing the figure of the critical moment from a desired viewpoint. The technique of Japanese Patent Laid-Open No. 2022-131778 makes it possible for the user to deepen the understanding on a critical moment expressed by a figure by using a virtual viewpoint image representing the appearances of the figure from a variety of viewpoints.

### SUMMARY

An information processing apparatus according to the present disclosure has: one or more memories storing instructions; and one or more processors executing the instructions to: obtain a captured image obtained by performing image capturing of a three-dimensional shaped product of an object, and a camera parameter indicating a position and an orientation of an imaging device used for the image capturing; obtain a virtual viewpoint image generated based on shape data of the object and the camera parameter, the virtual viewpoint image having a content of the virtual viewpoint image varying based on the number of the three-dimensional shaped products contained in the captured image; and perform a display control of the virtual viewpoint image.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram showing an example of a configuration of an information processing system which generates a virtual viewpoint image;

FIG. 2 is a diagram showing an example of installation of sensor systems;

FIG. 3 is an example of a table which is saved⋅managed by a database;

FIG. 4 is a diagram showing an example of a functional configuration of an image generation apparatus according to Embodiment 1;

FIG. 5 is a diagram showing an example of a hardware configuration of an image generation apparatus;

FIG. 6 is a flowchart showing a flow of generation processing of a virtual viewpoint image according to Embodiment 1;

FIGS. 7A and 7B are diagrams showing examples of captured images containing figures;

FIGS. 8A and 8B are diagrams showing examples of tables in which figure information is stored;

FIGS. 9A and 9B are diagrams showing examples of augmented reality images;

FIG. 10 is a diagram showing an example of a functional configuration of an image generation apparatus according to Embodiment 2;

FIG. 11 is a flowchart showing a flow of generation processing of a virtual viewpoint image according to Embodiment 2;

FIG. 12 is a diagram showing an example of a captured image containing figures;

FIG. 13 is a diagram showing an example of a table in which figure information is stored;

FIG. 14 is a diagram showing an example of an augmented reality image;

FIG. 15 is a diagram showing an example of a functional configuration of an image generation apparatus according to Embodiment 3;

FIG. 16 is a flowchart showing a flow of a generation processing of a virtual viewpoint image according to Embodiment 3;

FIG. 17 is a diagram showing an example of a captured image of figures;

FIG. 18 is a diagram showing an example of a table in which figure information is stored; and

FIG. 19 is a diagram showing an example of an augmented reality image.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

The technique of the above-described Japanese Patent Laid-Open No. 2022-131778 is to capture an image of a single figure with a camera to generate a virtual viewpoint image in the case where the figure is viewed from an image capturing viewpoint. For this reason, it was found by the consideration of the present inventors that a virtual viewpoint image obtained by this technique becomes only a relatively monotonous content which relies on an image capturing viewpoint of a user. The present disclosure has been made in view of such a point, and an object of the present disclosure is to provide a user with a virtual viewpoint image having higher added values in accordance with the number of figures contained in a captured image.

### First Embodiment

In the present embodiment, a mode of generating a virtual viewpoint image having a content varying in accordance with the number of 3D model figures captured in a captured image in an AR technique. Note that in the present Specification, a 3D model figure is simply referred to as a “figure”. In addition, a virtual viewpoint image is an image representing an appearance from a non-existent, virtual camera, and may be a moving image or may be a still image.

### Configuration of System

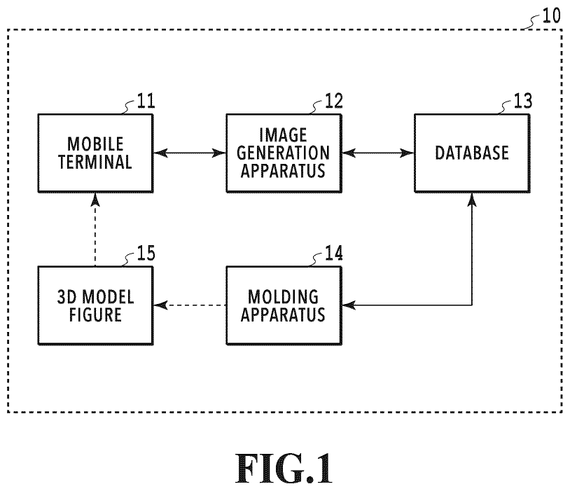

FIG. 1 is a block diagram showing an example of a configuration of an information processing system 10 which generates a virtual viewpoint image, according to the present embodiment. The information processing system 10 is configured with a mobile terminal 11, an image generation apparatus 12, a database 13, and a molding apparatus 14.

The mobile terminal 11 is an information processing apparatus having a camera function, such as a smartphone or a tablet terminal. The mobile terminal 11 superimposes and displays, in real time, a virtual viewpoint video generated by the image generation apparatus 12 on a video obtained by performing image capturing of a figure.

The image generation apparatus 12 is, for example, a server apparatus, and receives a captured image from the mobile terminal 11, and generates and provides a virtual viewpoint image by obtaining a 3D model corresponding to a figure captured in the captured image. Here, the 3D model is, for example, shape data which represents a three-dimensional shape of an object such as a person, which is a target of image capturing, by using a set (a point cloud) of points containing its color information. The 3D model is generated, for example, based on a plurality of images (multi-viewpoint images) which are obtained by performing image capturing of an object from a variety of angles by using a plurality of imaging devices. The image generation apparatus 12 generates various virtual viewpoint images in accordance with the number of figures in a captured image by using the obtained 3D model, and transmits the virtual viewpoint images to the mobile terminal 11, which is a transmission source of the captured image.

The database 13 saves⋅manages data which is used as materials for a figure and a virtual viewpoint image. Specifically, the database 13 saves⋅manages, in a table as described below, for example, data such as a multi-viewpoint image captured by sensor systems, which will be described later, a 3D model of an object captured in the multi-viewpoint image, a time code expressing a time of a moment represented by the 3D model. The time code is designated in a format of “Hour: Minute: Second: Frame Number”, for example. In this case, the frame number corresponds to a frame rate used at the time of image capturing, and takes values “0” to “59” in the case where the image capturing is performed at 60 fps, for example.

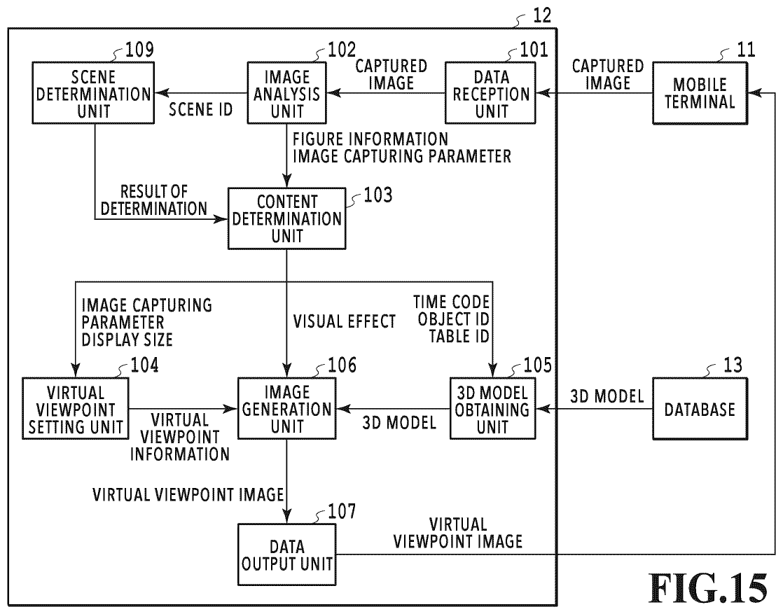

The molding apparatus 14 creates a FIG. 15, which is a three-dimensional shaped product formed of a material such as a resin or a plastic, by means of an approach such as a publicly-known 3D print, for example, using a 3D model saved⋅managed by the database 13. In the created FIG. 15, a code obtained by encoding information (an object ID, a time code, and a table ID) on the 3D model based on which the FIG. 15 has been created is attached to a surface or the like of a base or the figure. In the present embodiment, a two-dimensional marker will be described as an example of the code. The two-dimensional marker indicates a code configured with a pattern⋅dot⋅mark or the like arranged on a plane. Note that the code is not limited to a two-dimensional marker, but may be a one-dimensional marker such as a barcode, for example. In addition, the information on the 3D model may contain time information of a highlight scene in a specific event which is associated with a table ID of a table in which the target 3D model is stored, and the like. The highlight scene includes, for example, a walk-off home run or the like in a game of baseball, and the time information in this case is a time code indicating a start time and an end time which specify several seconds before and after the walk-off home run, for example.

### Generation and Saving of 3D Model

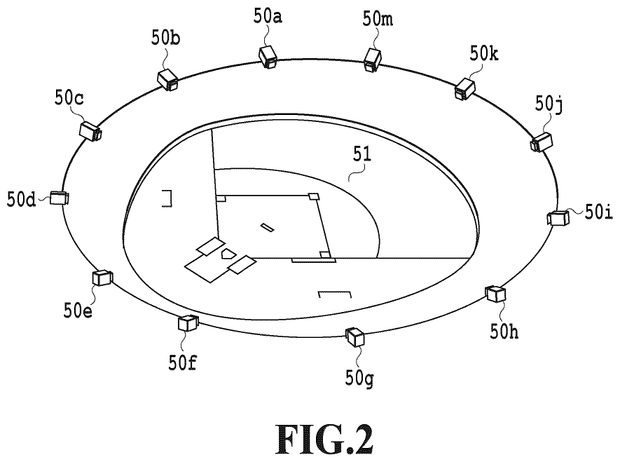

FIG. 2 is a diagram showing an example of installation of sensor systems for obtaining a multi-viewpoint image in a game of baseball. Sensor systems 50a-50m each having at least one imaging device (camera) are installed in such a manner as to surround an image capturing-target area 51 containing a field where the baseball is played and periphery thereof. Then, the sensor systems 50a-50m are synchronized in time and capture images of the image capturing-target area 51, so that a multi-viewpoint image can be obtained.

After a multi-viewpoint image is obtained as mentioned above, foreground areas corresponding to a player, a ball and the like are extracted from a plurality of captured images configuring the multi-viewpoint image by detecting differences between the plurality of captured images and an image (background image) obtained by performing image capturing of a state where there are no player or ball, for example, in advance to obtain foreground images. Then, point cloud data expressing three-dimensional shapes of the player, the ball, and the like is generated by a shape estimation method such as Visual Hull, for example, based on the plurality of foreground images thus obtained. A point cloud with color information can be obtained by adding, to each point configuring the point cloud thus generated, pixel values of captured images derived based on the position⋅orientation of each camera. Note that the determination of the color in each point is made such that a position on camera coordinates is specified by using a camera parameter indicating the position⋅orientation of the camera from the coordinates of the point on the three-dimension, and the color of the position of the camera coordinates is employed. At this time, in the case where the point is viewed from a plurality of cameras, a color of any one of the cameras may be used, or colors of a plurality of cameras may be blended.

In the present embodiment, a point cloud format with color information is used as a data format of a 3D model. However, the configuration is not limited to this. For example, the format representing a three-dimensional shape may be a voxel format or a mesh format, and color information does not have to be added. Note that in the case of a 3D model without color information added thereto, coloring may be performed by, for example, using an image captured from a viewpoint close to a virtual viewpoint in rendering an image corresponding to the virtual viewpoint. In addition, in the present embodiment, the method for generating a 3D model by Visual Hull using a multi-viewpoint image has been described. However, a 3D model may be generated by another method such as 3D scan or CG, for example.

Note that the number of sensor systems to be installed is not limited. In addition, the sensor systems do not have to be installed over the entire periphery of the image capturing-target area, and may be installed in only part of the periphery of the image capturing-target area depending on a limitation on installation locations or the like. In addition, the cameras included respectively in the plurality of sensor systems may include those having different functions, such as a telephoto camera and a wide-angle camera. In addition, each of the plurality of sensor systems may have a microphone (not shown) in addition to a camera. In the case where each of the plurality of sensor systems has a microphone, the microphones pick up sound in synchronization. Then, an acoustic signal which is played back along with the display of a virtual viewpoint image can be generated based on the sounds thus picked up. Although the description of sounds will be omitted below for simplifying the description, images and sounds are basically processed together.

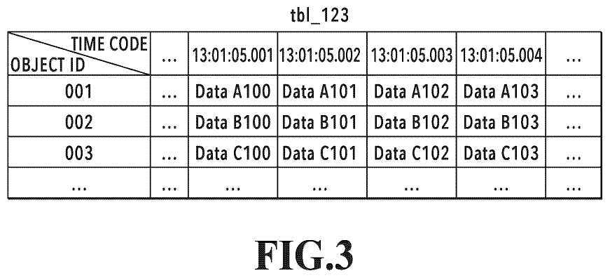

In the present embodiment, the database 13 holds data of 3D models generated as mentioned above in a table structure as shown in FIG. 3, for example, on a captured image file basis. In the table shown in FIG. 3, an object ID (001, 002, 003, . . . ) is added to each 3D model group according to the same object. Then, in the structure, 3D model data (Data A100, Data B100, . . . ) corresponding to each time indicated by a time code is associated with the object ID and stored. In addition, to each table, a table ID (tbl_123) for uniquely identifying the table is added, and the database 13 holds tables for the captured image files. In the case of holding data of 3D models by using a table as shown in FIG. 3, it is possible to read out and obtain a 3D model for each object at a desired moment in a specific event by designating a table ID, a time code, and an object ID. Note that the table of FIG. 3 is an example, and for example, as item values of the table, coordinates of the center of gravity, an object name (for example, a player name) of each 3D model, and the like may be provided.

### Example of Configuration of Image Generation Apparatus

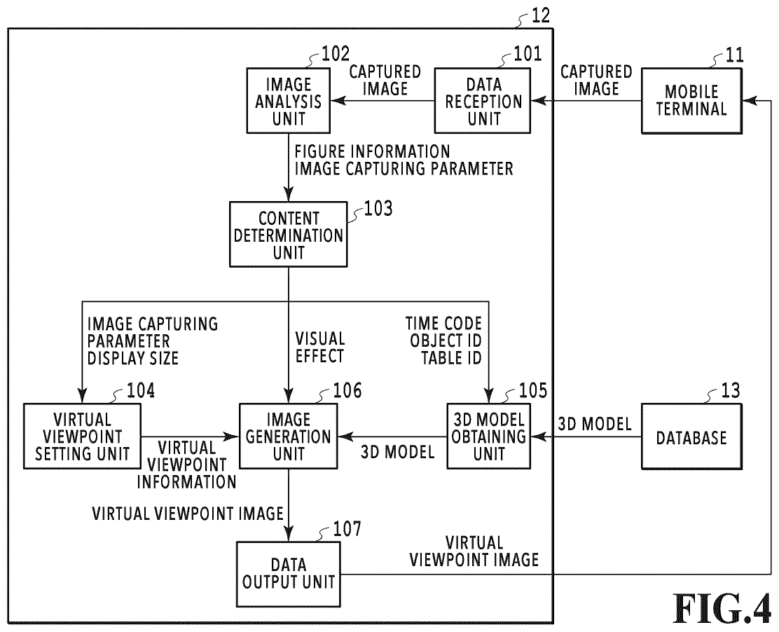

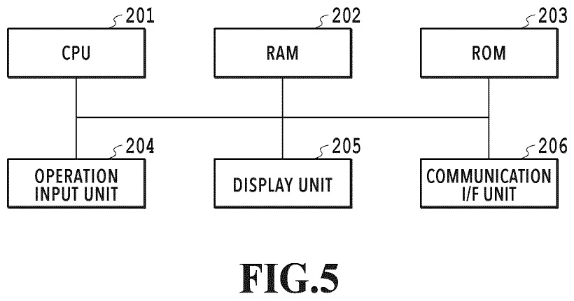

An example of a configuration of the image generation apparatus 12 according to the present embodiment will be described with reference to the drawings. FIG. 4 is a diagram showing a software configuration (functional configuration) of the image generation apparatus 12, and FIG. 5 is a diagram showing a hardware configuration of the image generation apparatus 12. Hereinafter, the example of the configuration will be described with reference to these drawings.

### Example of Software Configuration of Image Generation Apparatus

As shown in FIG. 4, the image generation apparatus 12 according to the present embodiment includes a data reception unit 101, an image analysis unit 102, a content determination unit 103, a virtual viewpoint setting unit 104, a 3D model obtaining unit 105, an image generation unit 106, and a data output unit 107.

The data reception unit 101 receives, from the mobile terminal 11, data of captured images in which a figure is captured. In addition, the data reception unit 101 receives, from the mobile terminal 11, data such as sensor values indicating changes in acceleration and orientation obtained by an acceleration sensor and a gyroscope sensor which are included by the mobile terminal 11 and not shown, and a focal length of a built-in camera. The received data such as captured images are inputted into the image analysis unit 102.

The image analysis unit 102 analyzes the inputted captured image, and extracts and decodes the code (the two-dimensional marker in the present embodiment) associated with each figure in the captured image to obtain information on each figure captured in the captured image. Here, the information on each figure contains an object ID for uniquely identifying a person or the like represented by the figure, a time code of a time of a moment represented by the figure, a table ID for uniquely identifying a table in which a 3D model of the figure is stored, and the like. In the following description, these pieces of information on a figure is referred to as “figure information”. Note that the extraction of a two-dimensional marker is performed, for example, by detecting an area corresponding to the two-dimensional marker in a captured image by means of pattern matching upon performing grayscale transformation, noise reduction, contrast adjustment, and the like on the captured image. Since a two-dimensional marker obtained in this way is expressed by a pattern of cells in black and white, figure information embedded in the two-dimensional marker is obtained by reading this pattern. The obtained figure information is inputted into the content determination unit 103. In addition, the image analysis unit 102 can specify the position and the orientation (direction) of the mobile terminal 11 based on a code or an image of the three-dimensional shaped product in the captured image. In the case of the present embodiment, the image analysis unit 102 calculates the position⋅orientation of the built-in camera relative to a figure based on the positions of the four corners of a two-dimensional marker extracted from a captured image, feature points of the figure captured therein, and the like.

The content determination unit 103 determines a display size of the object in the virtual viewpoint image in accordance with the number of figures captured in a captured image, and outputs the display size to the virtual viewpoint setting unit 104. In addition, the content determination unit 103 determines an visual effect in accordance with the number of figures captured in a captured image, and outputs the visual effect to the image generation unit 106. The determination of the display size and the visual effect in accordance with the number of figures will be described later. In addition, the content determination unit 103 outputs, to the 3D model obtaining unit 105, the object ID, the time code, the table ID based on figure information extracted from a captured image. Moreover, the content determination unit 103 outputs, to the virtual viewpoint setting unit 104, the camera parameter (an image capturing parameter) indicating image capturing conditions such as the position⋅orientation, and the focal length of the built-in camera, which are specified based on the above-mentioned sensor values received from the mobile terminal 11, and the result of the analysis.

The virtual viewpoint setting unit 104 sets virtual viewpoint information such as the position⋅orientation of a virtual camera based on information of the image capturing parameter and the display size inputted from the content determination unit 103. Here, the virtual camera is a virtual camera which is arranged on a virtual space (a CG space) corresponding to an actual space where the image capturing has been performed, and which does not exist in reality. An image representing an appearance of the object from this virtual camera is used as the virtual viewpoint image. The virtual viewpoint setting unit 104 first sets the position ·orientation of the mobile terminal 11 indicated by the inputted image capturing parameter as the position⋅orientation of the virtual camera. Moreover, the virtual viewpoint setting unit 104 changes the position of the virtual camera in accordance with the inputted display size, while maintaining the orientation. In this event, in the case where the position of the virtual camera is close to the 3D model of the figure, the object is displayed in a large size (expanded as compared with the captured image) in the virtual viewpoint image. In addition, in the case where the position of the virtual camera is far away from the 3D model of the figure, the object is displayed in a small size (contracted as compared with the captured image) in the virtual viewpoint image.

The 3D model obtaining unit 105 obtains, from the database 13, the 3D model specified based on the object ID, the table ID, the time code inputted from the content determination unit 103. Data of the obtained 3D model is inputted into the image generation unit 106.

The image generation unit 106 generates a virtual viewpoint image by performing rendering processing based on the 3D model inputted from 3D model obtaining unit 105, the virtual viewpoint information inputted from the virtual viewpoint setting unit 104, and the visual effect information inputted from the content determination unit 103.

The data output unit 107 transmits data of the virtual viewpoint image generated in the image generation unit 106 to the mobile terminal 11, which is a transmission source of the captured image data received by the data reception unit 101. Note that the destination to which the data output unit 107 outputs the virtual viewpoint image is not limited to the mobile terminal 11.

### Hardware Configuration of Image Generation Apparatus

Next, a hardware configuration of the image generation apparatus 12, which is an information processing apparatus, will be described. FIG. 5 is a diagram showing an example of the hardware configuration of the image generation apparatus 12.

A CPU 201 is a computation processing apparatus which controls an operation of the entire image generation apparatus 12, and implements each functional unit shown in FIG. 4 by executing predetermined programs stored in a ROM 203. Note that the image generation apparatus 12 may have one or a plurality of dedicated pieces of hardware different from the CPU 201, so that the dedicated pieces of hardware execute at least part of the processing by the CPU 201. Examples of dedicated hardware include ASIC (application-specific integrated circuit), FPGA (field-programmable gate array), DSP (digital signal processor), and the like.

The ROM 203 holds programs corresponding to the respective functional units shown in FIG. 4, and various kinds of data. The RAM 202 has a work area which temporarily store programs and data read out from the ROM 203. In addition, the RAM 202 provides a work area to be used by the CPU 201 to execute each processing.

An operation input unit 204 receives an input operation of the user via an input apparatus such as a keyboard or mouse, or a touch panel. A display unit 205 is, for example, a liquid-crystal display, and displays the state of the image generation apparatus 12, displays a generated virtual viewpoint image, and performs other operations.

A communication I/F unit 206 is an interface which controls communications with external apparatuses such as the database 13 and the mobile terminal 11 via a network such as a LAN, for example. For example, the communication I/F unit 206 receives 3D models from the database 13 via the Ethernet or the like. In addition, for example, the communication I/F unit 206 performs reception of captured image data, transmission of virtual viewpoint image data, and the like with the mobile terminal 11 via a near-field communication such as the Ethernet or the Bluetooth (registered trademark). In addition, the communication I/F unit 206 may perform transmission and reception of various kinds of data via an image output port such as HDMI (registered trademark) or SDI.

### Operation Flow of Image Generation Apparatus

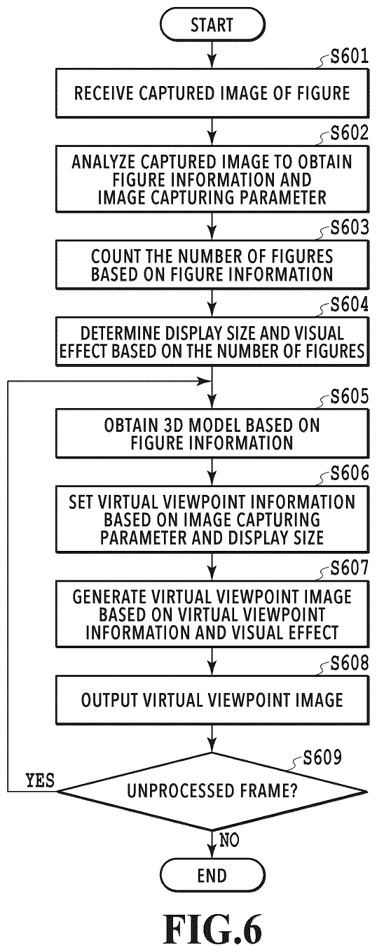

Subsequently, a flow of generation processing of a virtual viewpoint image in the image forming apparatus 12 according to the present embodiment will be described with reference to a flowchart of FIG. 6. Note that in the following description, sign “S” means a step.

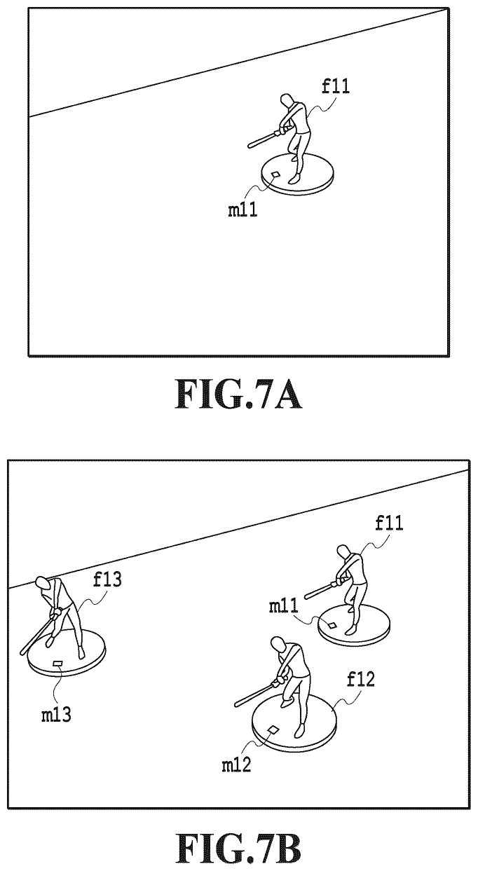

At S601, the data reception unit 101 receives, from the mobile terminal 11 a captured image in which a figure is captured. FIGS. 7A and 7B show examples of images obtained by the user performing image capturing of figures of baseball players which are placed on a desk, by using the camera function of the mobile terminal 11. FIG. 7A is an example of a captured image in which one figure f11 of a certain batter is captured, and FIG. 7B is an example of a captured image in which three figures f11, f12, and f13 of the same batter and the same posture are captured. To the bases of the respective figures, two-dimensional markers m11 to m13 in each of which figure information is stored are attached.

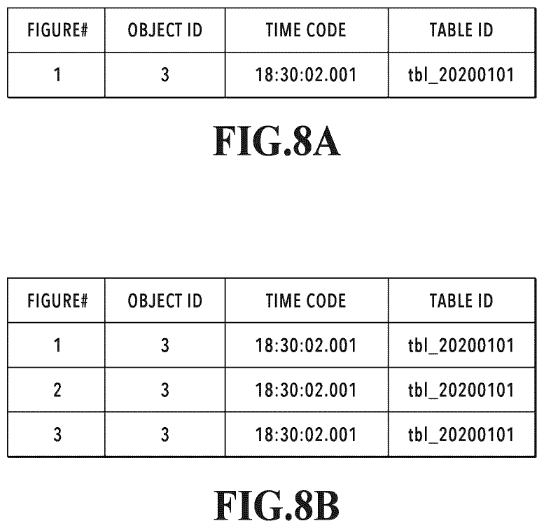

At S602, the image analysis unit 102 analyzes the captured image received at S601 to obtain figure information from each two-dimensional marker in the captured image. FIG. 8A is an example of a table in which figure information obtained from the captured image of above-mentioned FIG. 7A is stored, and FIG. 8B is an example of a table in which figure information obtained from the captured image of above-mentioned FIG. 7B is stored. In the table of FIG. 8A, information of an object ID, a time code, and a table ID of a 3D model corresponding to the one figure f11 is stored. In addition, in the table of FIG. 8B, information of object IDs, time codes, and table IDs of 3D models corresponding respectively to the three figures f11 to f13 is stored.

At S603, the content determination unit 103 counts the number of figures captured in the inputted captured image based on the figure information obtained at S602. In the case of the captured image of FIG. 7A, the number of figures=1 is obtained as a count value, and in the case of the captured image of FIG. 7B, the number of figures=3 is obtained as a count value.

At S604, the content determination unit 103 determines a display size and an visual effect of the 3D model (=the object) in a virtual viewpoint image which is to be generated at S607 described later, based on the number of figures obtained at S603.

### Determination of Display Size

For example, the display size is determined by using a threshold such that in the case where the number of figures is three or more, display size=“large”, in the case where the number of figures is two, display size=“middle”, and in the case where the number of figures is one, display size=“small”. In the case of the captured image of FIG. 7A, since the number of figures is one, it is determined that display size=“small”. In addition, in the case of the captured image of FIG. 7B, since the number of figures is three, it is determined that display size=“large”. Note that the expression format of the display size is not limited to large⋅middle⋅small. For example, the expression format may be expressed by numerical values of 1 to 10 such that the larger the numerical value is, the larger the display size is.

### Determination of Visual Effect

The visual effect is applied in order to draw viewer's attention, and is applied by synthesizing a virtual representation such as flame, spark, smoke, lightning, or luminescence, for example, to a foreground (area corresponding to an object) or its periphery in a virtual viewpoint image. For example, the visual effect is determined by using a threshold such that in the case where the number of figures is three or more, the visual effect is “applied”, and in the case where the number of figures is less than three, the visual effect is “not applied”. In the case of the captured image of FIG. 7A, since the number of figures is one, it is determined that the visual effect=“not applied”. In addition, in the case of the captured image of FIG. 7B, since the number of figures is three, it is determined that the visual effect=“applied”. Note that the determination of the visual effect is not limited to two options of “applied” and “not applied”. For example, the visual effect may be determined such that the larger the number of figures is, the more dramatic or larger in scale the content of the visual effect becomes.

At S605, the 3D model obtaining unit 105 obtains a corresponding 3D model based on the figure information obtained at S602. Specifically, the 3D model obtaining unit 105 obtains, from the database 13, a 3D model specified by the table ID, the object ID, and the time code indicated by the figure information. In the case of the captured image of FIG. 7A, a 3D model specified by the table ID=“tbl20200101”, the time code=“18:30:02.001”, and the object ID=“3” is obtained from the database 13 based on one piece of figure information shown by the table of FIG. 8A. In the case of the captured image of FIG. 7B, a 3D model specified by the table ID=“tbl20200101”, the time code=“18:30:02.001”, and the object ID=“3” is obtained from the database 13 based on three pieces of figure information shown by the table of FIG. 8B. Note that in the case of the table of FIG. 8B, all the three object IDs are the same, and all the three time codes are also the same. In this case, since the 3D models of the obtaining targets are common, the 3D model has to be obtained only once.

At S606, the virtual viewpoint setting unit 104 sets virtual viewpoint information based on the image capturing parameter of the mobile terminal 11 obtained at S602, and the display size determined at S606. Specifically, the virtual viewpoint setting unit 104 arranges a virtual camera of the same position·orientation as the position·orientation indicated by the image capturing parameter in a virtual three-dimensional space, and further adjusts the position of the virtual camera in accordance with the determined display size.

At S607, the image generation unit 106 arranges the 3D models obtained at S605 in the virtual space, and generates a virtual viewpoint image by performing rendering based on the virtual viewpoint information set at S606 and the visual effect determined at S604. In this event, the 3D models are arranged such that, for example, a foreground of the virtual viewpoint image is not laid over figures in the captured image in the case where the generated virtual viewpoint image is displayed in a superimposed manner on the captured image in the mobile terminal 11. Alternatively, 3D models may be intentionally arranged to be laid over figures.

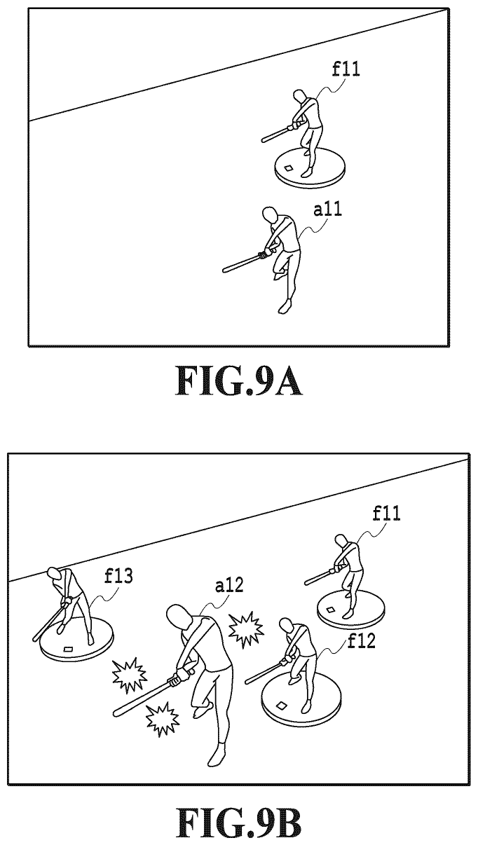

At S608, the data output unit 107 transmits the virtual viewpoint image generated at S607 to the mobile terminal 11. Then, in the mobile terminal 11 which has received the virtual viewpoint image, the virtual viewpoint image is displayed in a superimposed manner on the captured image obtained by the built-in camera, so that an augmented reality image is achieved. FIG. 9A shows an augmented reality image corresponding to the captured image of FIG. 7A in which the display size is “small” and the visual effect is “not applied”. As mentioned above, in the case of FIG. 7A in which only one figure is present in the captured image, a foreground a11 (=a virtual viewpoint image) in the augmented reality image is displayed in a representation form which has the same size as the figure in the captured image and has no visual effect. FIG. 9B shows an augmented reality image corresponding to the captured image of FIG. 7B in which the display size is “large” and the visual effect is “applied”. As mentioned above, in the case of FIG. 7B in which three figures are present in the captured image, a foreground a12 (=a virtual viewpoint image) in the augmented reality image is displayed in a representation form which is expanded as compared with the figures in the captured image and has an visual effect (here, spark).

At S609, it is determined whether or not there is an unprocessed frame based on the time codes of the figure information obtained at S602. If there is an unprocessed frame, the processing returns to S605, and the same processing is repeated. The above is the flow of the generation processing of a virtual viewpoint image in the image forming apparatus 12 according to the present embodiment.

### Modification

In the above-mentioned embodiment, the display size and the visual effect of an object in generating a virtual viewpoint image are set in accordance with the number of figures captured in a captured image. However, other parameters relating to a virtual viewpoint image may also be set. Other parameters include, for example, a trace of movement of a virtual viewpoint (virtual camera path), a resolution or a frame rate of a virtual viewpoint image, a playback time of a virtual viewpoint image, and the like. In the case of setting a virtual camera path according to the number of figures, for example, in the case where the number of figures has increased, a travel distance or a zoom magnification of a virtual camera may be changed (in the case where the number of figures is small, a virtual camera is moved half around the periphery of a 3D model, and a magnification is fixed, while in the case where the number of figures is large, the virtual camera is moved fully around the periphery, and the virtual camera is gradually zoomed in/zoomed out, or the like).

In the above-mentioned embodiment, the position of a virtual camera is changed in accordance with a determined display size. However, the configuration is not limited to this. For example, the quality of a 3D model itself which is a target of rendering processing may be changed in conformity with a determined display size. For example, point cloud data of three types “large”, “middle”, and “small” may be prepared in advance such that the point cloud data is obtained in conformity with a determined display size.

In addition, in the above-mentioned embodiment, a virtual viewpoint image is generated in the image generation apparatus 12, which is a server apparatus, and is provided to the mobile terminal 11, which is a user terminal. However, the configuration is not limited to this. For example, both image capturing of a figure and generation of a virtual viewpoint image may be performed in a user terminal which also has a function of an image generation apparatus.

As described above, according to the present embodiment, a virtual viewpoint image having a content varying depending on the number of figures in a captured image can be generated. This makes it possible to provide users with diverse and attractive augmented reality images.

### Second Embodiment

Subsequently, a mode of generating a virtual viewpoint image which reproduces the same motion in the case where a plurality of figures captured in a captured image respectively represent different moments in a series of movement (the same motion) of the same object will be described as Embodiment 2. Note that the contents such as the system configuration which are common with Embodiment 1 are omitted, and different points will be mainly described below.

### Example of Software Configuration of Image Generation Apparatus

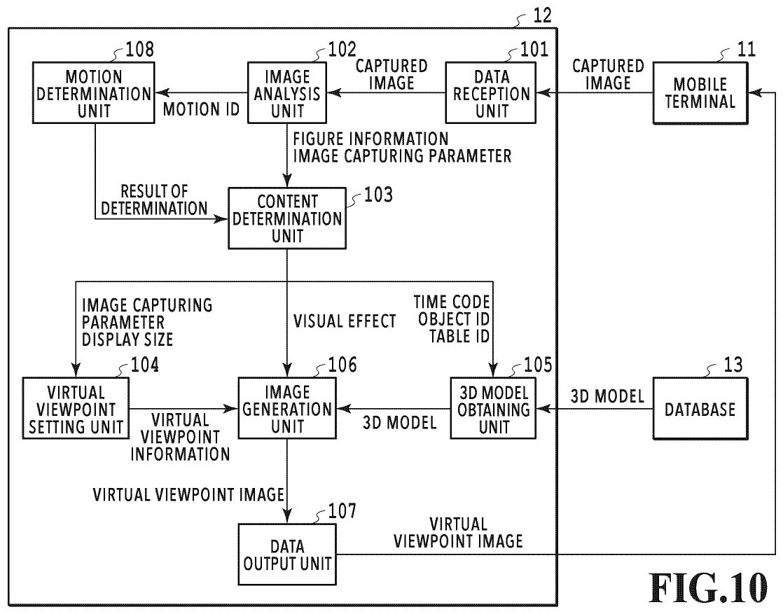

FIG. 10 is a diagram showing an example of a configuration of an image generation apparatus 12 according to the present embodiment. As shown in FIG. 10, the image generation apparatus 12 of the present embodiment includes a motion determination unit 108 in addition to the data reception unit 101, the image analysis unit 102, the content determination unit 103, the virtual viewpoint setting unit 104, the 3D model obtaining unit 105, the image generation unit 106, the data output unit 107, and the motion determination unit 108. Hereinafter, differences from Embodiment 1 will be described.

First, figure information in the present embodiment contains a motion ID. Here, the motion ID will be described. In the present embodiment, a motion means a series of actions of the same object (a baseball player in the present embodiment) such as bat swing of a batter or pitching of a pitcher in baseball, for example. Then, the motion ID is identification information for uniquely specifying a motion. This motion ID is added to part of figure information by a user in creating a figure in the molding apparatus 14, for example. Then, the figure information containing the motion ID is encoded to generate a code such as a two-dimensional marker, which is attached to a base of the figure, or the like. Note that the motion ID may be automatically generated based on the shape or the like of a 3D model corresponding to a created figure, and added to the figure information.

In the case where a plurality of figures are present in a captured image, the motion determination unit 108 determines whether or not 3D models corresponding to the respective figures relate to the same motion by using motion IDs stored in pieces of figure information corresponding to the plurality of figures. Note that the method for determining whether or not 3D models relate to the same motion is not limited to the method using motion IDs. For example, whether or not 3D models relate to the same motion may be determined by an approach such as pattern matching based on the shapes of 3D models corresponding to the respective figures.

In the case where the motion determination unit 108 has determined that the 3D models relate to the same motion, the content determination unit 103 specifies a time code indicating the earliest time of the motion and a time code indicating the latest time of the motion based on attached information of the motion IDs. Then, the content determination unit 103 determines a generation period of time for a virtual viewpoint image by using the specified time code indicating the earliest time as a “start time code” and the specified time code indicating the latest time as an “end time code”.

In the case where the above-mentioned generation period of time has been determined, the image generation unit 106 generates a virtual viewpoint image which reproduces the series of actions indicated by the motion ID, by using 3D models associated with time codes between time indicated by the start time code relating to the generation period of time and time indicated by the end time code relating to the generation period of time.

The above is rough differences of each functional unit included in the image generation apparatus 12 according to the present embodiment from Embodiment 1.

### Operation Flow of Image Generation Apparatus

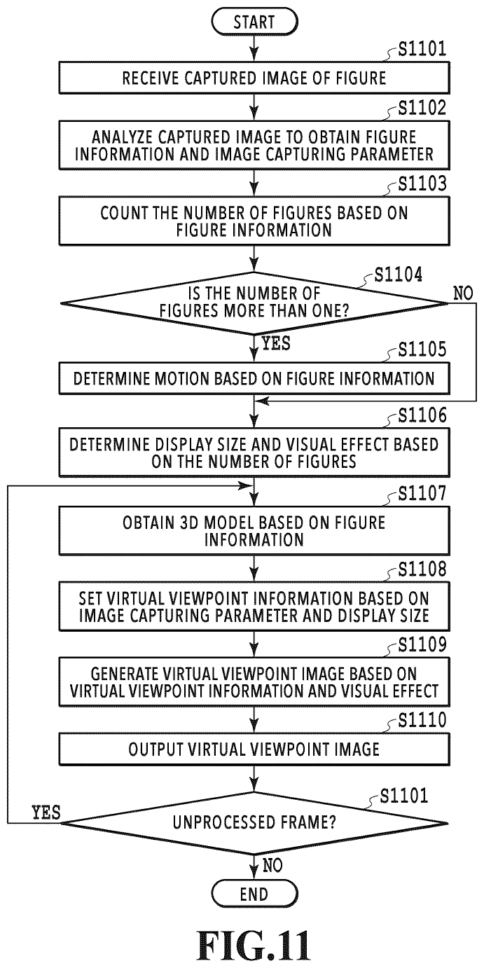

Subsequently, a flow of generation processing of a virtual viewpoint image in the image forming apparatus 12 according to the present embodiment will be described with reference to a flowchart of FIG. 11 mainly in terms of the differences from Embodiment 1. Note that in the following description, sign “S” means a step.

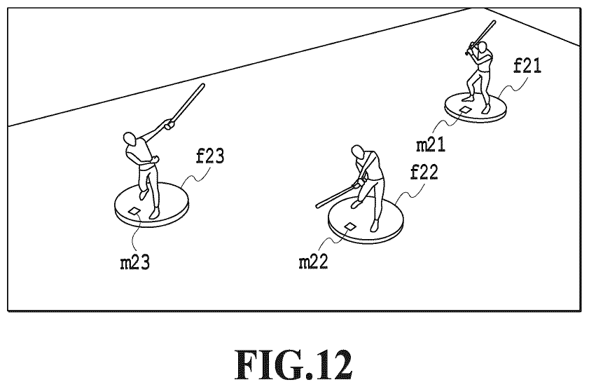

At S1101, the data reception unit 101 receives a captured image in which figures are captured from the mobile terminal 11. FIG. 12 shows an example of an image obtained by the user using the camera function of the mobile terminal 11 and performing image capturing of figures of baseball players placed on a desk. The example of FIG. 12 is an example of a captured image in which three figures f21, f22, and f23 each of which captured a moment of bat swing of the same batter are captured. To the bases of the respective figures, two-dimensional markers m21 to m23 in each of which figure information is stored are attached.

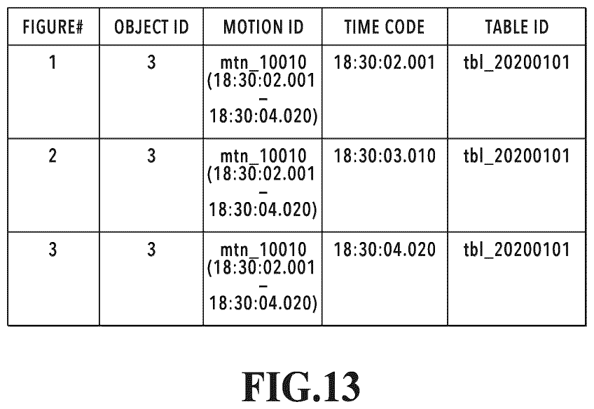

At S1102, the image analysis unit 102 analyzes the captured image received at S1101 to obtain figure information from each two-dimensional marker in the captured image. FIG. 13 is an example of a table showing the figure information obtained from the captured image of above-mentioned FIG. 12. In the table of FIG. 13, object IDs, time codes, and table IDs, and also motion IDs of 3D models corresponding respectively to the three figures f21 to f23 are stored. Then, in each motion ID (mtn_10010), a time code (18:30:02.001-18:30:04.020) of a start time and an end time of the motion is also stored together as the attached information.

At S1103, the content determination unit 103 counts the number of figures captured in the inputted captured image, based on the figure information obtained at S1102. In the case of the captured image of FIG. 12, the number of figures=3 is obtained as the count value.

At S1104, processing to be executed next is switched depending on whether or not the count value obtained at S1103 is more than one. If the count value is more than one (two or more), S1105 is executed next, and if the count value is not more than one (less than two), S1106 is executed next.

At S1105, the motion determination unit 108 determines whether or not the 3D models specified by the respective pieces of figure information relate to the same motion, based on the motion IDs contained in the plurality of pieces of figure information obtained at S1102. As shown by the table of FIG. 13, in the case of the captured image of FIG. 12, since all the motion IDs stored in the three pieces of figure information are the same, it is determined that the 3D models relate to the same motion.

At S1106, the content determination unit 103 determines a display size and an visual effect of each object in a virtual viewpoint image which is to be generated at S1109 described later, based on the number of figures obtained at S1103. Then, in the case where it is determined that the 3D models relate to the same motion at S1105 like the captured image of FIG. 12, a generation period of time of the virtual viewpoint image is determined based on the attached information of the motion IDs contained in the figure information.

At S1107, the 3D model obtaining unit 105 obtains corresponding 3D models based on the figure information obtained at S1102. Here, if it has been determined that the 3D models relate to the same motion at S1105, 3D models corresponding to the respective times from the start time code of the generation period of time determined at S1106 to the end time code thereof are sequentially obtained. In this event, 3D models only for frames obtained by decimating to equal intervals like once in two frames may be obtained, instead of obtaining 3D models for all the frames from the start time code to the end time code. In the case where there are a plurality of pieces of figure information for which it has been determined that the 3D models relate to the same motion in this way, 3D models are obtained in such a manner as to fill between time codes indicated respectively by the plurality of pieces of figure information. Note that in the case where it has been determined that the 3D models do not relate to the same motion at S1105, the processing described in Embodiment 1 is executed.

At S1108, like aforementioned S606, the virtual viewpoint setting unit 104 sets virtual viewpoint information based on the image capturing parameter of the mobile terminal 11 obtained at S1102 and the display size determined at S1106.

At S1109, like aforementioned S607, the image generation unit 106 arranges the 3D models obtained at S1107 in the virtual space, and generates a virtual viewpoint image by performing rendering based on the virtual viewpoint information set at S1108 and the visual effect determined at S1106. In this event, the 3D models are arranged such that, for example, the foreground of the virtual viewpoint image is not laid over figures in the captured image in the case where the generated virtual viewpoint image is displayed in a superimposed manner on the captured image in the mobile terminal 11. Alternatively, 3D models may be intentionally arranged to be laid over any figure.

At S1110, like aforementioned S608, the data output unit 107 transmits the virtual viewpoint image generated at S1109 to the mobile terminal 11. Then, in the mobile terminal 11 which has received the virtual viewpoint image, the virtual viewpoint image is displayed in a superimposed manner on the captured image obtained by the built-in camera, so that an augmented reality image is achieved.

At S1111, like aforementioned S609, it is determined whether or not there is an unprocessed frame based on the time codes of the figure information obtained at S1102. If there is an unprocessed frame, the processing returns to S1107, and the same processing is repeated. Here, in the case where it has been determined at S1105 that the 3D models relate to the same motion, the processing is repeated up to the frame of the end time code of the generation period of time determined at S1106.

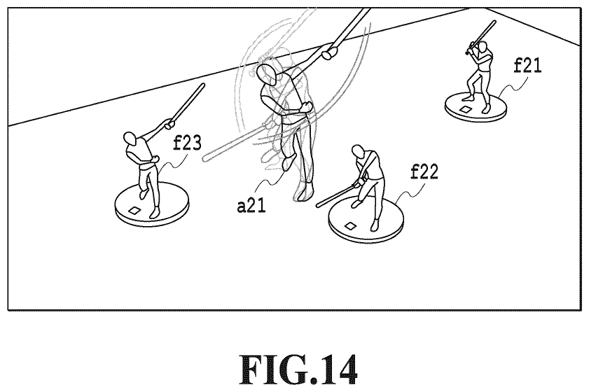

The above is the flow of the generation processing of a virtual viewpoint image in the image forming apparatus 12 according to the present embodiment. FIG. 14 shows an augmented reality image corresponding to the captured image of FIG. 12. In the augmented reality image shown in FIG. 14, which is achieved by the present embodiment, bat swing of the player of the object ID=3, which is represented by the three figures f21 to f23, are displayed in a moving image in the foreground a21(=virtual viewpoint image). Then, in the example of FIG. 14, the object is expanded and an visual effect as emphasizing the bat swing path is added. Note that in the example of FIG. 14, the position⋅orientation of the virtual viewpoint is fixed during the determined generation period of time, but may be changed in accordance with the number of figures, for example (for example, gradually comes closer, or moves from the viewpoint near the ground to a bird's-eye viewpoint, or the like).

As described above, according to the present embodiment, in the case where a plurality of figures show the respective moments in a series of actions, a virtual viewpoint image in which intervals between times indicated by the respective moments are complemented can be generated. This makes it possible for the user to enjoy an augmented reality image which reproduces a series of actions represented by figures.

### Third Embodiment

Subsequently, a mode of generating a virtual viewpoint image which reproduces a specific scene in the case where a plurality of figures captured in a captured image represent the specific scene with a plurality of objects will be described as Embodiment 3. Note that the contents such as the system configuration which are common with Embodiment 1 are omitted, and different points will be mainly described below.

### Example of Software Configuration of Image Generation Apparatus

FIG. 15 is a diagram showing an example of a configuration of an image generation apparatus 12 according to the present embodiment. As shown in FIG. 15, the image generation apparatus 12 of the present embodiment includes a scene determination unit 109 in addition to the data reception unit 101, the image analysis unit 102, the content determination unit 103, the virtual viewpoint setting unit 104, the 3D model obtaining unit 105, the image generation unit 106, the data output unit 107, and the scene determination unit 109. Hereinafter, differences from Embodiment 1 will be described.

First, figure information in the present embodiment contains a scene ID. Here, the scene ID will be described. In the present embodiment, the scene ID is identification information for uniquely specifying a highlight scene during a game, such as match-up between an ace pitcher and a fourth batter in baseball, for example. This scene ID is added to part of figure information by a user in creating a figure in the molding apparatus 14, for example, like the motion ID in Embodiment 2. Then, the figure information containing the scene ID is encoded to generate a code such as a two-dimensional marker, which is attached to a base of the figure, or the like. Note that the scene ID may also be automatically generated based on the shape or the like of a 3D model of a created figure, and added to the figure information, like the motion ID.

In the case where a plurality of figures are present in a captured image, the scene determination unit 109 determines whether or not 3D models corresponding to the respective figures relate to the same scene by using scene IDs stored in pieces of figure information corresponding to the plurality of figures. Note that the method for determining whether or not 3D models relate to the same scene is not limited to the method using scene IDs. For example, whether or not 3D models relate to the same scene may be determined based on an approach such as pattern matching based on the shapes of 3D models corresponding to the respective figures. In addition, it may be determined that 3D models relate to the same scene in the case where a difference between a time code of one 3D model and a time code of the other 3D model is equal to or less than threshold, and are thus temporally close to each other, for example.

In the case where the scene determination unit 109 has determined that 3D models relate to the same scene, the content determination unit 103 specifies a time code indicating the earliest time of the scene and a time code indicating the latest time of the scene based on attached information of the scene ID. Then, the content determination unit 103 determines a generation period of time for a virtual viewpoint image by using the specified time code indicating the earliest time as a “start time code” and the specified time code indicating the latest time as an “end time code”.

In the case where the scene determination unit 109 has determined that the 3D models relate to the same scene, the virtual viewpoint setting unit 104 generates virtual viewpoint information by setting the position of a virtual camera such that the 3D models of object IDs stored in the respective pieces of figure information fall within the angle of view.

In the case where the above-mentioned generation period of time has been determined, the image generation unit 106 generates a virtual viewpoint image which reproduces a specific scene indicated by the scene ID, by using 3D models associated with time codes between time indicated by the start time code relating to the generation period of time and time indicated by the end time code relating to the generation period of time.

The above is rough differences of each functional unit included in the image generation apparatus 12 according to the present embodiment from Embodiments 1 and 2.

### Operation Flow of Image Generation Apparatus

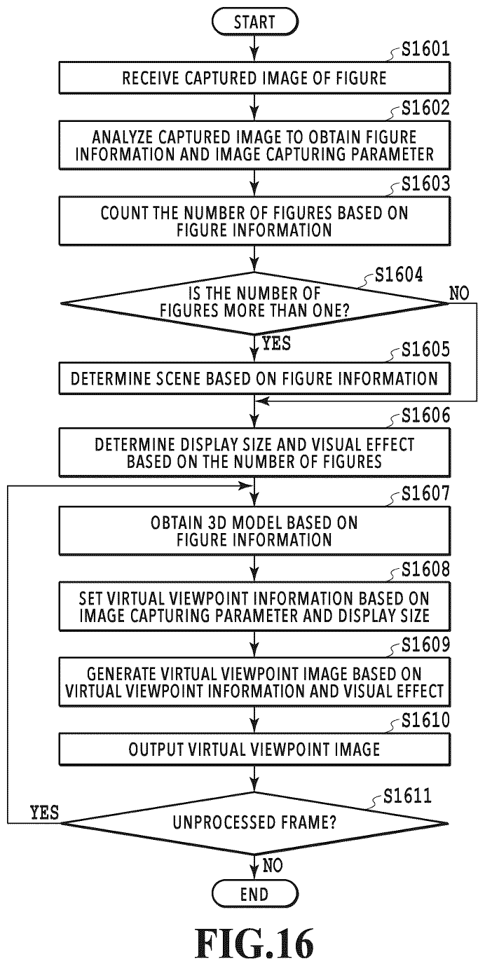

Subsequently, a flow of generation processing of a virtual viewpoint image in the image forming apparatus 12 according to the present embodiment will be described with reference to a flowchart of FIG. 16 mainly in terms of the differences from Embodiments 1 and 2. Note that in the following description, sign “S” means a step.

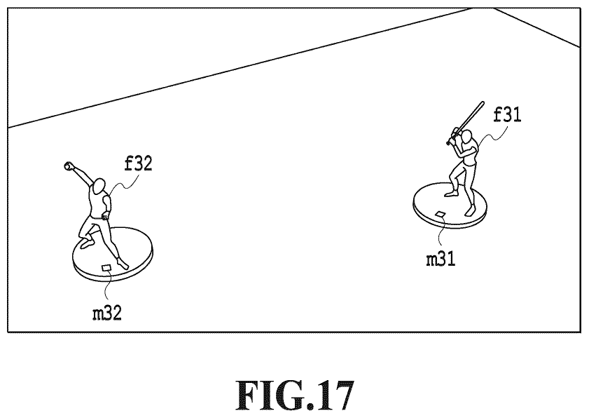

At S1601, the data reception unit 101 receives a captured image in which figures are captured from the mobile terminal 11. FIG. 17 is an example of an image obtained by the user using the camera function of the mobile terminal 11 and performing image capturing of figures of baseball players placed on a desk. The example of FIG. 17 is an example of a captured image in which a figure f31 of a batter and a figure f32 of a pitcher are captured. To the bases of the respective figures, two-dimensional markers m31 and m32 in each of which figure information is stored is attached.

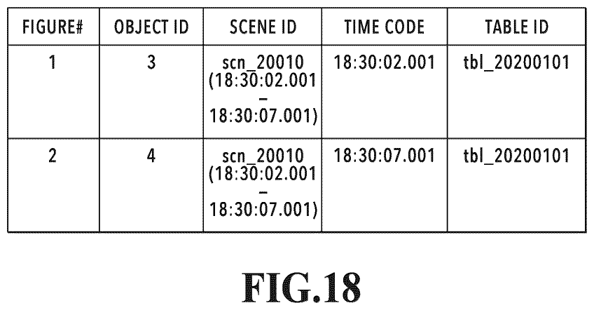

At S1602, the image analysis unit 102 analyzes the captured image received at S1601 to obtain figure information from each two-dimensional marker in the captured image. FIG. 18 is an example of a table showing the figure information obtained from the captured image of above-mentioned FIG. 17. In the table of FIG. 18, object IDs, time codes, and table IDs, and also scene IDs of 3D models corresponding respectively to the two figures f31 and f32 are stored. Then, in each scene ID (scn_20010), a time code (18:30:02.001-18:30:07.001) of a start time and an end time of the motion is also stored together as attached information.

At S1603, the content determination unit 103 counts the number of figures captured in the inputted captured image, based on the figure information obtained at S1602. In the case of the captured image of FIG. 17, the number of figures=2 is obtained as the count value.

At S1604, processing to be executed next is switched depending on whether or not the count value obtained at S1603 is more than one. If the count value is more than one (two or more), S1605 is executed next, and if the count value is not more than one (less than two), S1606 is executed next.

At S1605, the scene determination unit 109 determines whether or not the 3D models specified by the respective pieces of figure information relate to a specific scene, based on the scene IDs contained in the plurality of pieces of figure information obtained at S1602. As shown by the table of FIG. 18, in the case of the captured image of FIG. 17, since all the scene IDs stored in the two pieces of figure information are the same, it is determined that the 3D models specified by the respective pieces of figure information relate to the specific scene.

At S1606, the content determination unit 103 determines a display size and an visual effect of each object in a virtual viewpoint image which is to be generated at S1609 described later, based on the number of figures obtained at S1603. Then, in the case where the 3D models relate to the specific scene at S1605 like the captured image of FIG. 17, a generation period of time of the virtual viewpoint image is determined based on the attached information of the scene IDs contained in the figure information.

At S1607, the 3D model obtaining unit 105 obtains corresponding 3D models based on the figure information obtained at S1602. Here, if it has been determined that the 3D models relate to the specific scene at S1605, 3D models corresponding to the respective times from the start time code of the generation period of time determined at S1606 to the end time code thereof are sequentially obtained. In this event, 3D model only for frames obtained by decimating to equal interval like once in two frames may be obtained, instead of obtaining 3D models for all the frames from the start time code to the end time code. In the case where there are a plurality of pieces of figure information for which it has been determined that the 3D models relate to the specific scene in this way, 3D models are obtained in such a manner as to fill between time codes indicated respectively by the plurality of pieces of figure information. Note that in the case where it has been determined that the 3D models do not relate to the specific scene at S1605, the processing described in Embodiment 1 is executed.

At S1608, like aforementioned S606, the virtual viewpoint setting unit 104 sets virtual viewpoint information based on the image capturing parameter of the mobile terminal 11 obtained at S1602 and the display size determined at S1606.

At S1609, like aforementioned S607, the image generation unit 106 arranges the 3D models obtained at S1607 in the virtual space, and generates a virtual viewpoint image by performing rendering based on the virtual viewpoint information set at S1608 and the visual effect determined at S1606. In this event, in the case where the specific scene is match-up between a pitcher and a batter, for example, it is desirable to arrange the 3D models in conformity with the position relationship between the pitcher and the batter in an actual game.

At S1610, like aforementioned S608, the data output unit 107 transmits the virtual viewpoint image generated at S1609 to the mobile terminal 11. Then, in the mobile terminal 11 which has received the virtual viewpoint image, the virtual viewpoint image is displayed in a superimposed manner on the captured image obtained by the built-in camera, so that an augmented reality image is achieved.

At S1611, like aforementioned S609, it is determined whether or not there is an unprocessed frame based on the time codes of the figure information obtained at S1602. If there is an unprocessed frame, the processing returns to S1607, and the same processing is repeated. Here, in the case where it has been determined at S1605 that the 3D models relate to the specific scene, the processing is repeated up to the frame of the end time code of the generation period of time determined at S1606.

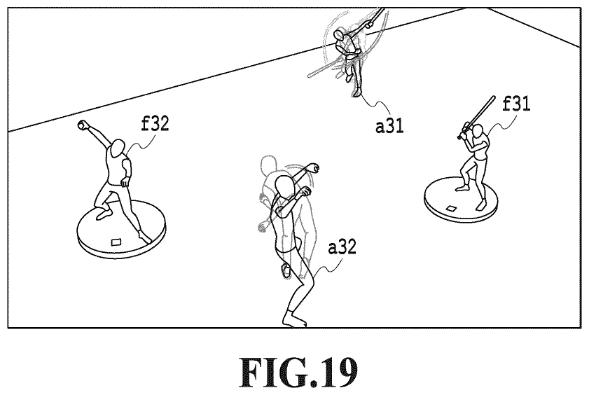

The above is the flow of the generation processing of a virtual viewpoint image in the image forming apparatus 12 according to the present embodiment. FIG. 19 shows an augmented reality image corresponding to the captured image of FIG. 17. In the augmented reality image shown in FIG. 19, which is achieved by the present embodiment, how the pitcher is throwing a ball and the batter is swinging a bat, which are represented by the two figures f31 and f32, are displayed in a moving image in foregrounds a31 and a32 (=virtual viewpoint images). Then, in the example of FIG. 19, in order to obtain a virtual viewpoint image having a higher sense of presence, the position of the virtual camera is set such that the 3D model of the batter falls within the angle of view as viewed from behind the 3D model of the pitcher. Note that in the example of FIG. 19 as well, like Embodiment 2, the position⋅orientation of the virtual viewpoint is fixed during the determined generation period of time, but may be changed in accordance with the number of figures, for example (for example, gradually comes closer, or moves from the viewpoint near the ground to a bird's-eye viewpoint, or the like).

### Modification Example

In the present embodiment, a virtual viewpoint image of the entire scene is generated based on the start time code and the end time code indicated by the attached information of the scene ID. However, a virtual viewpoint image of a partial period of time of a scene may be generated.

In addition, in the present embodiment, in the case where it is determined that 3D models relate to a specific scene from the scene IDs, a virtual viewpoint image which reproduces the specific scene is generated by using the 3D models. However, the configuration is not limited to this. For example, for 3D models corresponding to all players who belong to the same team, a group ID which identifies the team is added. Then, a group ID is extracted from each of a plurality of pieces of figure information obtained by performing image capturing of a plurality of figures captured in a captured image, and in the case where it is determined that the 3D models belong to the same team, an visual effect unique to the team, which is set in advance, may be applied, or the like.

As described above, according to the present embodiment, in the case where a plurality of figures indicate the respective moments in a specific scene, a virtual viewpoint image in which intervals between times indicated by the respective moments are complemented is generated. This makes it possible for the user to enjoy an augmented reality image which reproduces a specific scene represented by figures.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

The present disclosure makes it possible to provide users with diverse and attractive virtual viewpoint images, and enhance the value of use of 3D model figures.

This application claims the benefit of Japanese Patent Application No. 2024-229358, filed Dec. 25, 2024 which is hereby incorporated by reference herein in its entirety.

What is claimed is:

1. An information processing apparatus comprising:
one or more memories storing instructions; and
one or more processors executing the instructions to:
obtain a captured image obtained by performing image capturing of three-dimensional shaped product of an object, and a camera parameter indicating a position and an orientation of an imaging device used for the image capturing;
obtain a virtual viewpoint image generated based on shape data of the object and the camera parameter, the virtual viewpoint image having a content varying depending on the number of the three-dimensional shaped products contained in the captured image; and
perform a display control of the virtual viewpoint image.

2. The information processing apparatus according to claim 1, wherein
the one or more processors further execute the instructions to:
analyze the obtained captured image to obtain information on the three-dimensional shaped product, and the camera parameter indicating the position and the orientation of the imaging device used for the image capturing;
determine the content of the virtual viewpoint image based on the number of the three-dimensional shaped products contained in the obtained captured image; and
obtain the shape data of the object based on the obtained information on the three-dimensional shaped product.

3. The information processing apparatus according to claim 2, wherein
the virtual viewpoint image having the determined content is obtained by generation processing using virtual viewpoint information based on the obtained shape data and the obtained camera parameter.

4. The information processing apparatus according to claim 3, wherein
as the content of the virtual viewpoint image, a size of the object in the virtual viewpoint image is determined based on the number of the three-dimensional shaped products.

5. The information processing apparatus according to claim 4, wherein
a size of the object in a case where the number of the three-dimensional shaped products is a first number is larger than a size of the object in a case where the number of the three-dimensional shaped products is a second number which is smaller than the first number.

6. The information processing apparatus according to claim 4, wherein
the virtual viewpoint information contains information of a position and an orientation of a virtual camera, and
the position of the virtual camera is a position obtained by changing, in accordance with the determined size of the object, the position of the imaging device indicated by the obtained camera parameter.

7. The information processing apparatus according to claim 2, wherein
as the content of the virtual viewpoint image, an visual effect in the virtual viewpoint image is determined based on the number of the three-dimensional shaped products.

8. The information processing apparatus according to claim 7, wherein
the visual effect is a virtual representation to a foreground in the virtual viewpoint image, and
the content of the visual effect in a case where the number of the three-dimensional shaped products is a first number is more dramatic or larger in scale than the content of the visual effect in a case where the number of the three-dimensional shaped products is a second number which is smaller than the first numbers.

9. The information processing apparatus according to claim 7, wherein
the visual effect is a virtual representation to a foreground in the virtual viewpoint image,
in a case where the number of the three-dimensional shaped products is less than two, it is determined not to apply the visual effect,
in a case where the number of the three-dimensional shaped products is two or more, it is determined to apply the visual effect.

10. The information processing apparatus according to claim 2, wherein
the information on the three-dimensional shaped product is obtained by extracting, from the captured image, a code in which the information on the three-dimensional shaped product is encoded, and decoding the code.

11. The information processing apparatus according to claim 2, wherein
the shape data represents a three-dimensional shape of the object at a certain time,
the information on the three-dimensional shaped product contains an object ID which identifies the object and a time code which indicates the time, and
the shape data is obtained based on the object ID and the time code.

12. The information processing apparatus according to claim 2, wherein
in a case where the number of the three-dimensional shaped products contained in the obtained captured image is more than one, and the plurality of three-dimensional shaped products relate to the same motion of the same object, a virtual viewpoint image which reproduces the same motion is generated in the generation processing.

13. The information processing apparatus according to claim 12, wherein
the one or more processors further execute the instructions to:
in the case where the number of the three-dimensional shaped products contained in the obtained captured image is more than one, determine whether or not the plurality of three-dimensional shaped products relate to the same motion of the same object.

14. The information processing apparatus according to claim 13, wherein
the information on the three-dimensional shaped product contains identification information for uniquely specifying a motion, and
whether or not the plurality of three-dimensional shaped products relate to the same motion of the same object is determined based on the identification information contained in the obtained information on the three-dimensional shaped products.

15. The information processing apparatus according to claim 2, wherein
in a case where the number of the three-dimensional shaped products contained in the obtained captured image is more than one, and the plurality of three-dimensional shaped products relate to the same scene, a virtual viewpoint image which reproduces the same scene is generated in the generation processing.

16. The information processing apparatus according to claim 15, wherein
the one or more processors further execute the instructions to:
in the case where the number of the three-dimensional shaped products contained in the obtained captured image is more than one, determine whether or not the plurality of three-dimensional shaped products relate to the same scene.

17. The information processing apparatus according to claim 16, wherein
the information on the three-dimensional shaped product contains identification information for uniquely specifying a scene, and
whether or not the plurality of three-dimensional shaped products relate to the same scene is determined based on the identification information contained in the obtained information on the three-dimensional shaped products.

18. The information processing apparatus according to claim 10, wherein
the camera parameter is obtained based on a code in which the information on the three-dimensional shaped product is encoded, or an image of the three-dimensional shaped product, the code or the image being contained in the captured image.

19. An information processing method comprising:
obtaining a captured image obtained by performing image capturing of a three-dimensional shaped product of an object, and a camera parameter indicating a position and an orientation of an imaging device used for the image capturing;
obtaining a virtual viewpoint image generated based on shape data of the object and the camera parameter, the virtual viewpoint image having a content varying depending on the number of the three-dimensional shaped products contained in the captured image; and
performing a display control of the virtual viewpoint image.

20. A non-transitory computer readable storage medium storing a program for causing a computer to perform an information processing method comprising:
obtaining a captured image obtained by performing image capturing of a three-dimensional shaped product of an object, and a camera parameter indicating a position and an orientation of an imaging device used for the image capturing;
obtaining a virtual viewpoint image generated based on shape data of the object and the camera parameter, the virtual viewpoint image having a content varying depending on the number of the three-dimensional shaped products contained in the captured image; and
performing a display control of the virtual viewpoint image.
